(19) United States
(12) Patent Application Publication
(10) Pub. No.: US 2008/0288362 A1
(43) Pub. Date: Nov. 20, 2008

(54) ONLINE SHOPPING SYSTEMS AND METHODS THAT INCLUDE A GAMING EXPERIENCE FOR SHOPPERS

(75) Inventor: Adam L. King, San Jose, CA (US)

Correspondence Address: PATENT LAW PROFESSIONALS, P.O. BOX 612407, San Jose, CA, 95161, US

(73) Assignee: bamwoo!

(21) Appl. No.: 11/859,985

(22) Filed: Sep. 24, 2007

Related U.S. Application Data
(60) Provisional application No. 60/917,918, filed on May 14, 2007.

(51) Int. Cl. G06Q 30/00; G06F 17/00; G06F 17/40

(52) U.S. Cl. 705/26; 705/400

(57) ABSTRACT

Systems and methods for conducting or facilitating online shopping transactions that include gaming experiences for buyers/shoppers are disclosed. An exemplary method includes receiving a request to purchase an item which is offered for sale by an online seller from an online buyer/shopper, and, in response to receiving said request to purchase the item, determining an actual sales price of the item from among the plurality of possible sales prices using a gaming mechanism. According to one aspect of the invention, the gaming mechanism operates to determine the actual sales price in response to the buyer's/shopper's interaction with attributes of the gaming mechanism displayed to the buyer/shopper via, for example, an Internet browser. Generating visual attributes of a gaming mechanism for an online buyer/shopper to view and interact with during an online shopping transaction makes the online shopping experience a more exciting and enjoyable process, compared to prior art online shopping approaches.

### CROSS-REFERENCE TO RELATED APPLICATIONS

This application claims the benefit of U.S. Provisional Patent Application No. 60/917,918, filed on May 14, 2007, the content of which is hereby incorporated by reference in entirety.

### FIELD OF THE INVENTION

The present invention relates to online business transactions. More particularly, the present invention relates to online shopping systems and methods that include a gaming experience for shoppers.

### BACKGROUND OF THE INVENTION

The Internet has evolved into a powerful vehicle for conducting business transactions. Every day, millions of people and businesses use the Internet to buy and sell just about every product and service imaginable. This “online” approach to buying and selling goods and services (commonly referred as “electronic commerce” or “eCommerce”) has, in many instances, displaced traditional forms of commerce. One significant advantage of electronic commerce is that it does not require face-to-face meetings between buyers and sellers, thereby avoiding the time and expense that would otherwise be required of the buyer and seller to meet at a physical location.

Another advantage of electronic commerce is that it increases the number of potential sellers. Unlike traditional sellers, online sellers do not need to have a “brick-and-mortar” building (i.e., a physical building) to transact business. This attribute of electronic commerce allows sellers who do not have the resources necessary to pay for property costs, such as rent, for example, to participate in the online market. The greater number of sellers results in increased competition and lower prices. Competition among sellers also results from the sellers' being aware that online shoppers/buyers have the ability to efficiently shop numerous online stores before settling on a final purchase.

While electronic commerce has become a competitive and efficient way of performing business transactions, it is often a dull and unexciting process for shoppers, particularly for those shoppers who desire excitement in their shopping experience. In a typical electronic business transaction, a shopper is presented with a list or menu of products or services that are available for purchase on a vendor's website. Through a graphical user interface (GUI) provided by a browser, the shopper manipulates a mouse or keyboard to select a desired item from the list or menu. The selected item is then electronically placed in an electronic version of a “shopping cart.” After the shopper has selected all of the items he or she wishes to purchase, a check-out procedure is executed in which the shopper enters his or her payment information and shipping information. The electronic business transaction process is completed once the authenticity of the shopper and the shopper's payment and shipping information (e.g., credit card number and address) have been verified.

As can be seen, prior art online shopping approaches can be quite dull and do not offer or involve an exciting shopping experience for shoppers. It would be desirable, therefore, to have systems and methods for online shopping that offer a fun and exciting experience to shoppers.

### BRIEF SUMMARY OF THE INVENTION

Systems and methods for conducting or facilitating online shopping transactions that include gaming experiences for buyers/shoppers are disclosed. An exemplary method includes receiving a request to purchase an item which is offered for sale by an online seller from an online buyer/shopper, and, in response to receiving the request to purchase the item, determining an actual sales price of the item from among the plurality of possible sales prices using a gaming mechanism. According to one aspect of the invention, the gaming mechanism operates to determine the actual sales price in response to the buyer's/shopper's interaction with attributes of the gaming mechanism displayed to the buyer/shopper via, for example, an Internet browser. Other methods are described and claimed below.

An exemplary system for facilitating an online shopping transaction includes a first computing subsystem adapted to offer an item for sale according to operation of a gaming mechanism and a second computing subsystem configured to access the offer via a computer network (e.g., via the Internet). The first computing subsystem is operable to receive an agreement from an operator of the second computing subsystem to purchase the item at a price determined by the gaming mechanism. The second computing system is configured to display visual attributes of the gaming mechanism. The operator of the second computing system (e.g., a buyer/shopper) can view these visual attributes, and, in some embodiments, also interact with them, during the online shopping transaction. Other systems are described and claimed below.

The gaming mechanism can be implemented in various ways. According to one embodiment of the invention, it is implemented as a computer software applet or a software routine provided by the seller for operation on the buyer's/shopper's computer (e.g., within the buyer's/shopper's web browser). The applet or software routine and the buyer's/shopper's browser together operate to render images for display to the buyer/shopper. The images include visual attributes of the gaming mechanism and/or associated images of a plurality of possible prices the buyer/shopper is willing to pay for an item offered for sale. According to one aspect of the invention, the images comprise time-varying (e.g., animated) features of the game of the gaming mechanism, which the buyer/shopper may both visually enjoy and interact with during the online shopping transaction in determining an actual price to be paid for the item offered for sale. The gaming mechanism may be configured to provide any number of different types of games, some of which are described below as including a spinning cube, a roulette-like wheel partitioned into a number of sectors, a multi-faceted die, and a deck of playing cards.

By including a gaming mechanism as part of an online shopping transaction, online shopping is made to be a more enjoyable and exciting experience, compared to prior art electronic shopping methods.

Further features and advantages of the present invention, as well as the structure and operation of the above-summarized and other exemplary embodiments of the invention, are described in detail below with respect to accompanying drawings, in which like reference numbers are used to indicate identical or functionally similar elements.

### BRIEF DESCRIPTION OF THE DRAWINGS

FIG. 1 is a diagram showing an exemplary online shopping transaction system that includes a gaming experience for buyers, according to an embodiment of the present invention;

FIG. 2 is a block diagram illustrating salient components of an exemplary computing device, in accordance with one embodiment of the present invention;

FIGS. 3A-3D are drawings showing a series of web pages provided by a vendor's or seller's website during an online shopping transaction including a gaming experience with the use of a gaming mechanism, in accordance with an embodiment of the present invention;

FIGS. 3E-3G are drawings showing alternative gaming mechanisms that may be used instead of the exemplary gaming mechanism used in FIGS. 3A-3D; and

FIG. 4 is a flowchart illustrating an exemplary process of facilitating online shopping transactions that includes a gaming experience for buyers, according to an embodiment of the present invention.

### DETAILED DESCRIPTION

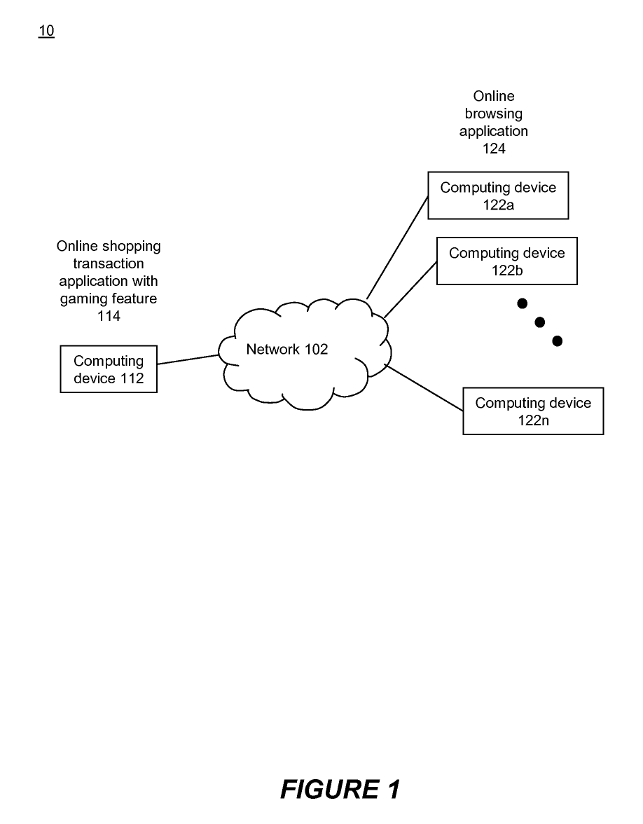

Referring first to FIG. 1, there is shown an exemplary online shopping transaction system 10 that includes a gaming experience for buyers, according to an embodiment of the present invention. The online shopping transaction system 10 comprises a first computing device 112 configured to execute an online shopping transaction application that includes a gaming feature 114 at least one second computing device 122 having an online browsing application 124 (e.g., a web browser) installed thereon, and a computer data network 102 through which the first computing device 112 and the at least one of said second computing devices 122a-122n are coupled.

The online shopping transaction application with gaming feature 114 is configured to receive remote commands electronically (e.g., a confirmed purchase request, selection of an item, etc.) from, and send reply or acknowledgement commands or messages to, one of the second computing devices 122a-122n over the data network 102 (e.g., the Internet).

According to one embodiment of the present invention, the online shopping transaction application with gaming feature 114 comprises a website offering products (e.g., goods or services) for sale by a seller. One or more buyers may purchase offered products via a web browser 124 (e.g., Firefox, Opera, Internet Explorer, etc.) over the Internet (i.e., the data network 102). The gaming feature provides the buyers a gaming experience while purchasing goods/services through a website created by such online shopping transaction application 114. In particular, the gaming feature includes a gaming mechanism capable of producing a set of random outcomes (or predetermined outcomes in an alternative embodiment). The set of outcomes is further divided into a number of subsets with each subset designated to one of corresponding pre-set prices. Buyers would pay for the product with one of the pre-set prices based upon the outcome of the gaming mechanism. More details of the gaming feature and gaming experience are explained below.

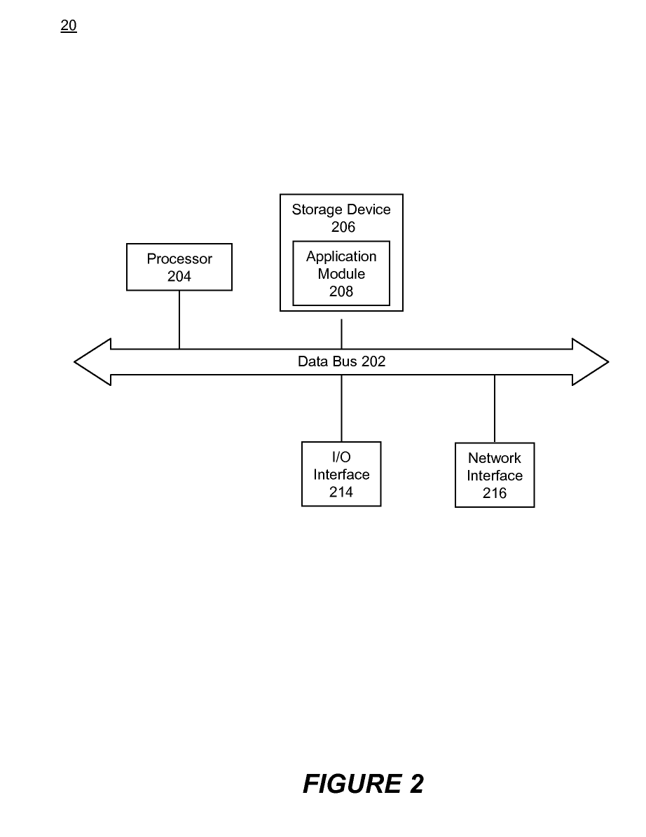

FIG. 2 is a block diagram illustrating salient components of an exemplary computing device 20 which may be used to implement the first and second computing device 112 and 122a-122n in FIG. 1. Each computing device 20 includes a processor 204 coupled to a data bus 202. Also coupled to the data bus 202 are a storage device 206, an I/O interface 214 and a network interface 216. The processor 204 (e.g., microprocessor, microcontroller, or central processing unit (CPU)) is configured to execute programming instructions, and/or other directives, to synchronize operations of the various devices and interfaces coupled to the data bus 202. The storage device 206 is configured to store an application module 208 (e.g., online shopping transaction application 114 of FIG. 1) containing program instructions for the processor 204 to execute. The storage device 206 may comprise, but is not limited to, random access memory (RAM), read only memory (ROM), flash memory, Electronically Erasable Programmable Read Only Memory (EEPROM or EPROM), registers, hard disk drives, removable disk, compact disk (CD-ROM), Digital Versatile Disc (DVD), any combination of these storage devices, or any other form of storage medium that may be separate from or integrated with the processor 204. The application module 208 may also be referred to as a software module, or executable by those of ordinary skill in the art.

The I/O interface 214 is configured to allow a user to interact with the computing device 20 via, for example, a keyboard and/or a pointing device (e.g., a mouse, a trackball, etc.). Although not shown in the drawing, a display monitor and one or more speakers are also included for viewing visual output (e.g., texts and/or graphics) and listening to audio output (e.g., sounds, voices, etc.), respectively. The networking interface 216 is included to provide the computing device 20 the ability to communicate with other computing devices (e.g., the computing devices 122a-122n in FIG. 1) over the data network 102 (e.g., the Internet) wired or wireless.

According to the various embodiments of the present invention, an online shopping transaction is conducted between an online seller (i.e., vendor) and an online buyer (i.e., shopper) over the data network (e.g., the Internet, World Wide Web, or Local Area Network (LAN)). The seller offers products or services in a website hosted by the seller's computer (e.g., the first computing device 112 in FIG. 1) and/or third party computers, while the buyer uses a web browser 124 (e.g., Firefox, Internet Explorer, Opera, etc.) installed on the buyer's computer (e.g., the second computing devices 122a-122n in FIG. 1) to access the website to make an online purchase.

The seller's website comprises one or more web pages containing product information (e.g., price, product descriptions, etc.). Each of the web pages comprises computer code created using a computer language (e.g., Hypertext Markup Language (HTML), Extensible Markup Language (XML), Hypertext Preprocessor (PHP), etc.). Once created, the computer code is stored in a storage device (e.g., the storage device 206) in the seller's computer. Each web page is identified by a unique web address (i.e., Uniform Resource Locator (URL)) that can be located and accessed by other computing devices coupled to the network. For example, once the online shopper/buyer enters the web address of a particular web page in the browser, the stored computer code is accessed (i.e., downloaded) and then executed and/or interpreted by the browser. The stored computer code includes information such as text, metadata of text (e.g., size, font, color, format, etc.), image, metadata of image (e.g., location, size, etc.), and other hyperlinks.

In accordance with embodiments of the invention, one or more of the web pages include, or include links to an applet that provides the gaming features the online shopper/buyer can view and/or interact with. For the purpose of this disclosure an “applet” is meant to refer to a software component that runs in the context of the browser and which is operable to render a series of animated images in the buyer's/shopper's browser. The applet may be run as soon as the web page is accessed (e.g., the shopper enters the web address), may be configured to run for a pre-set time period, after which it stops automatically, or is configured to run continuously until interrupted by a command issued by the buyer or seller. According to one embodiment, the applet begins running as soon as the web page is accessed (e.g., as soon as the buyer's/shopper's browser links to the seller's website address), and continues to run until the buyer/shopper provides a command which stops the animation (e.g., a “buy” command). According to an alternative embodiment the applet is activated and halted only in response to start and stop commands issued by the buyer/shopper via the browser. In any one or more of these embodiments, the applet, in addition to providing a graphical interface that can be interacted with by the buyer/shopper, may be configured to forward commands from the buyer/shopper back to the seller's server (e.g., to a servlet configured on the seller's server) for processing. Finally, while an applet has been described in this exemplary embodiment as being configured for execution by the buyer's/shopper's browser, in alternative embodiments the computer code for the gaming mechanism may be configured for distributed execution on both the buyer's and seller's computers, as will be appreciated by those of ordinary skill in the art.

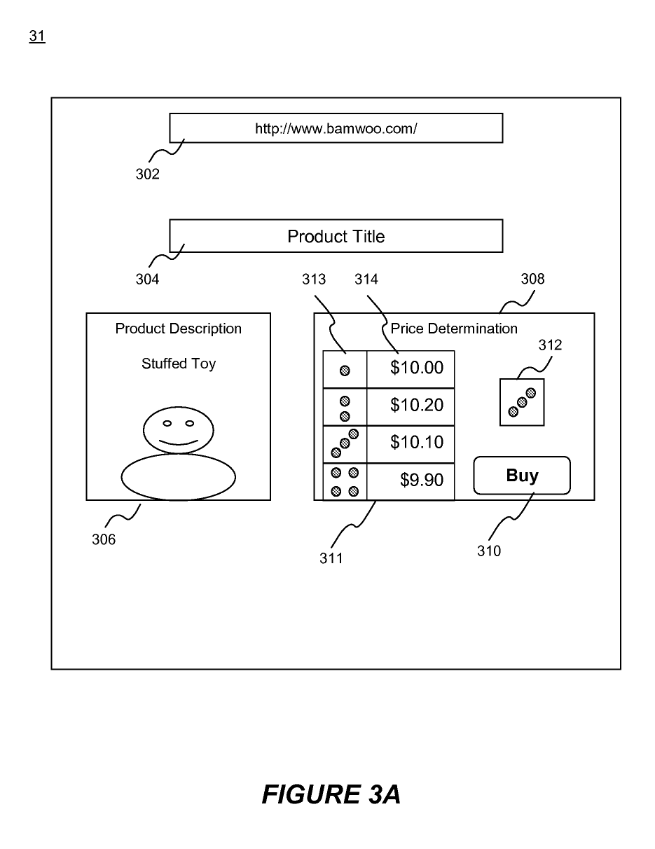

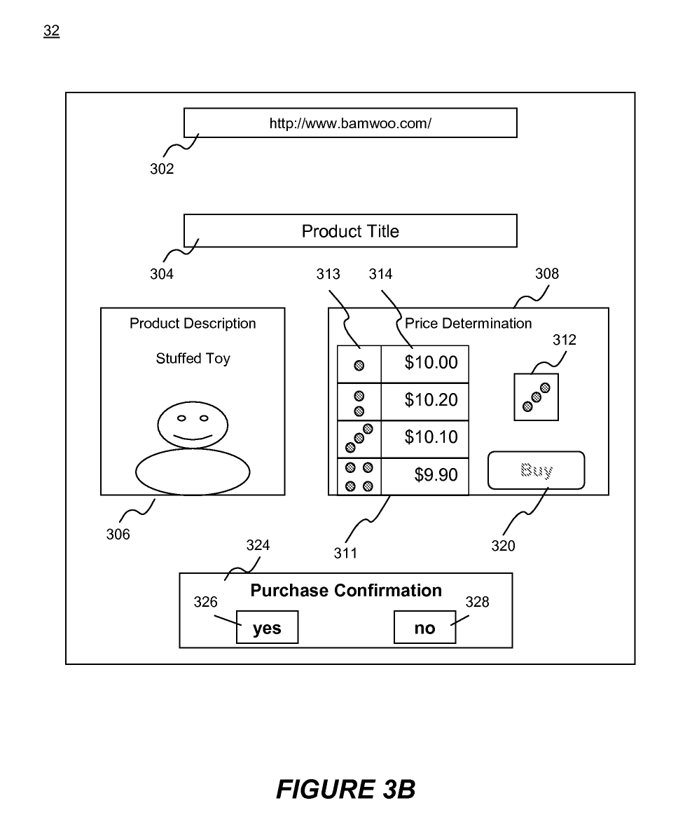

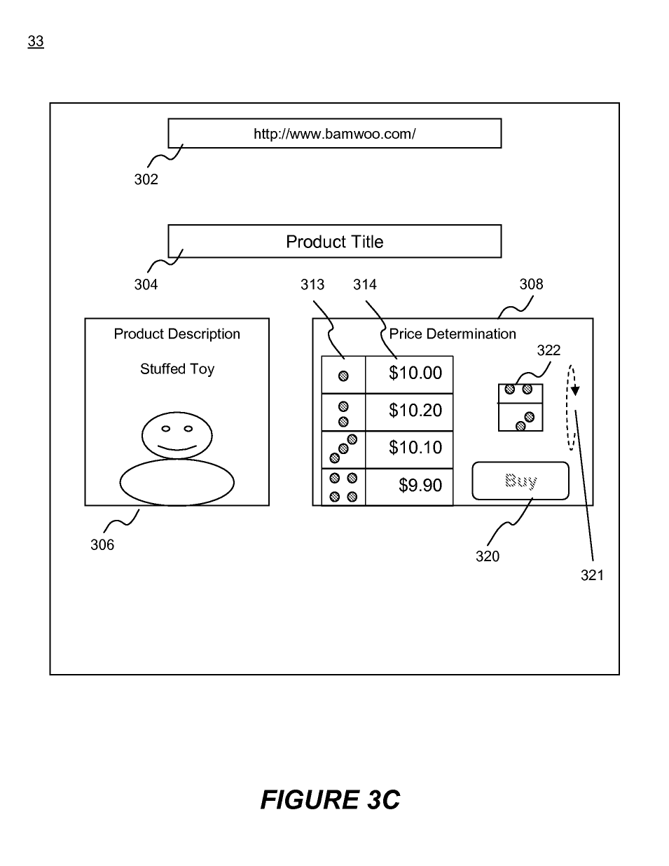

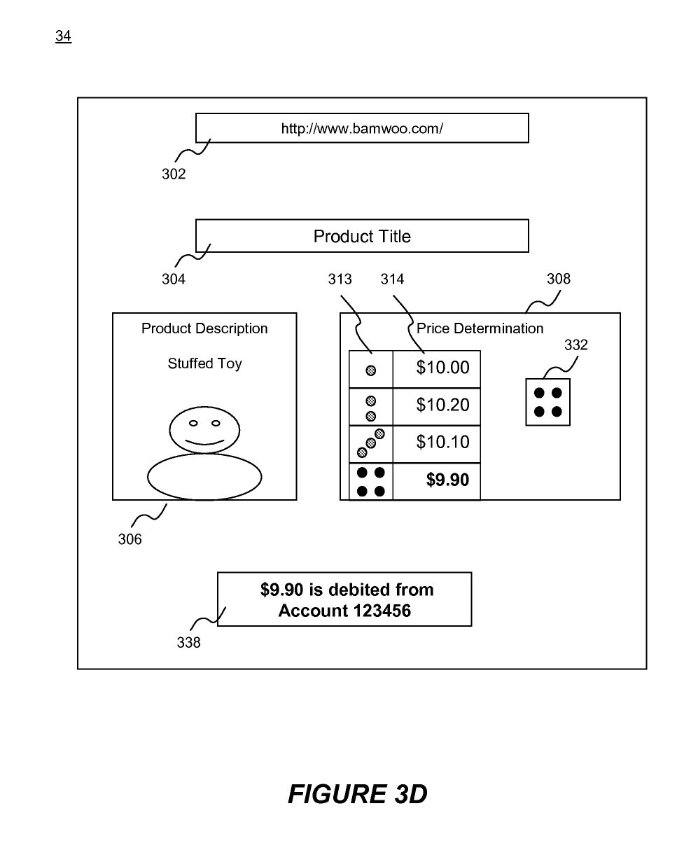

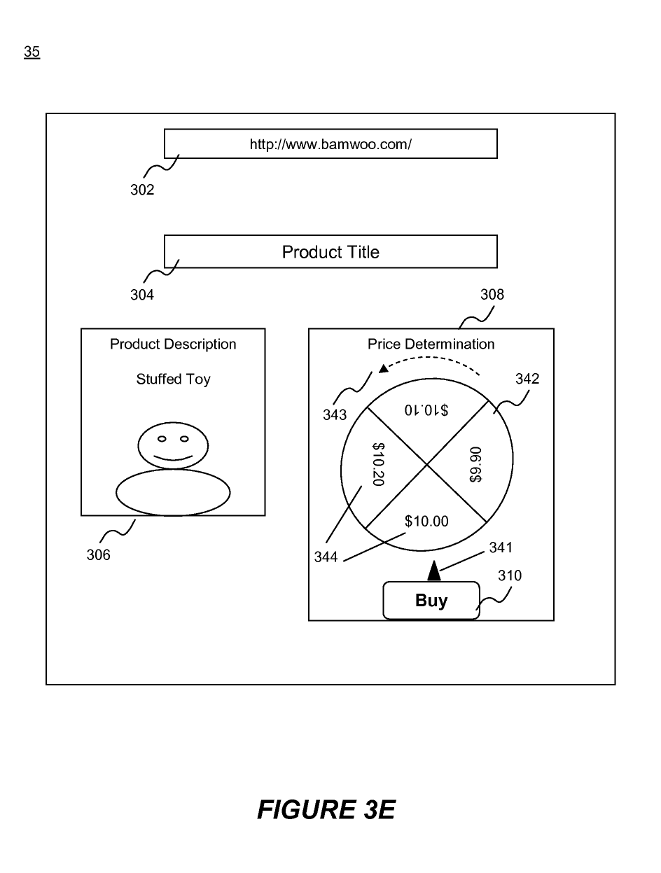

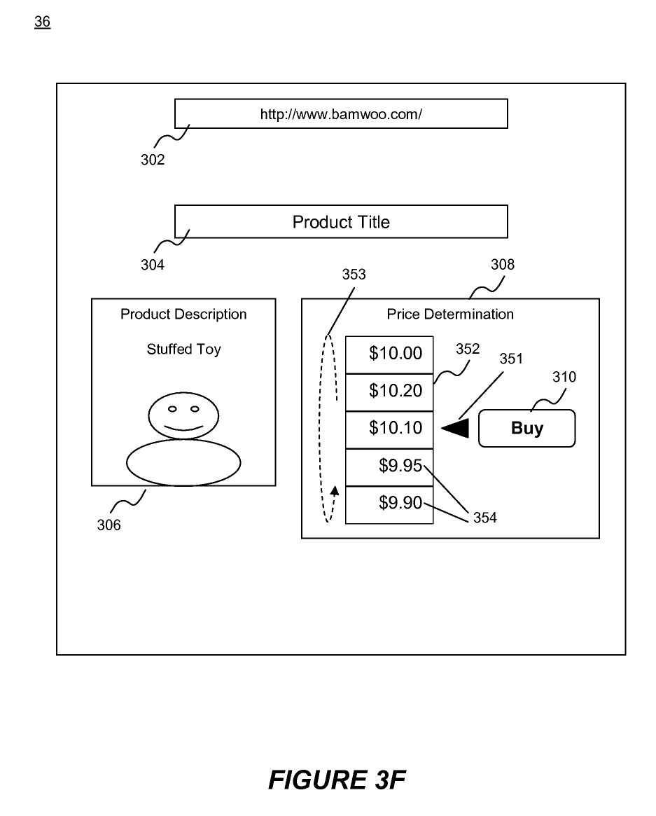

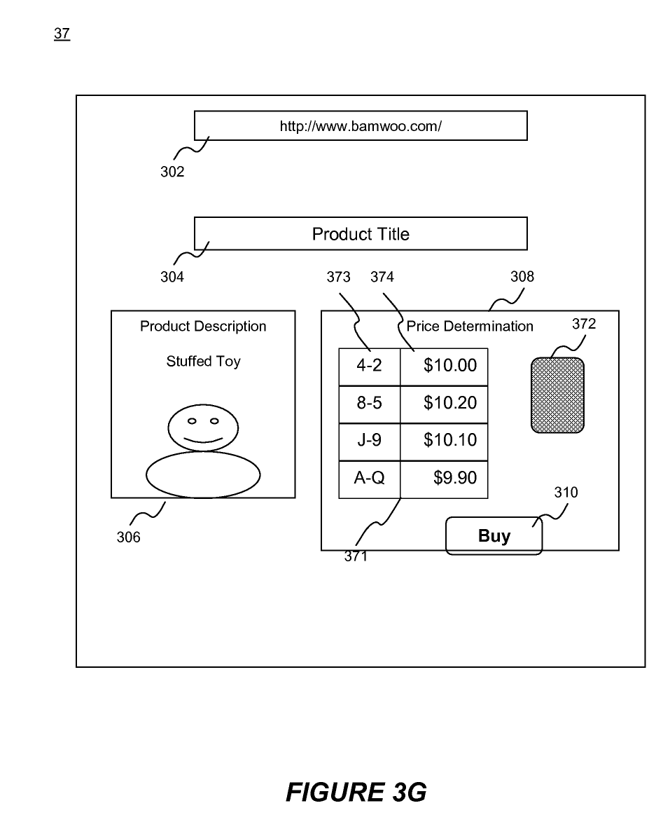

FIGS. 3A-3D shown a series of web pages 31-34 provided by a vendor's website (e.g., a website created by the online shopping transaction application 114 of FIG. 1) during an online shopping transaction, in accordance with an embodiment of the present invention. The first web page 31 in FIG. 3A shows a product (in this example, a stuffed animal) offered for sale in an online shopping transaction. The first web page 31 may include, but is not necessarily limited to, a web address 302 (e.g., www.bamwoo.com), a title of one of the products (i.e., goods or services) 304 that a buyer is desirous to acquire, more details about the product or service (e.g., a picture of a stuffed animal), links to other web pages or websites containing more detailed information 306 of the product, a price determination block or section 308 that includes a gaming mechanism 312 (in this example, a four-faceted die), a purchase activation (“buy”) button 310 for the user to submit a buy request, and a price-outcome correlation table 311.

The four-faceted die 312 is capable of producing four different or distinct outcomes as indicated in a first column 313 of the table 311. Each of the possible outcomes corresponds to a pre-set price, as shown by the column of pre-set prices in the second column 314 of the table 311. The pre-set prices may be determined by the seller such that the buyer would receive one of the pre-set prices for this product depending upon which face of the four-faceted die 312 would end up (e.g., simulated by the online shopping transaction application 114). The “buy” button 310 is configured for the buyer or user to submit a purchase request. For example, the user may click a mouse button while the cursor is over the button 310 in one instance, or the user may press an “enter” key on the keyboard to achieve the same function. The “buy” button 310 may also be labeled as a special button, for example, a “bamwoo!” button.

As the buyer submits the purchase request through the “buy” button 310, a second web page 32, shown in FIG. 3B, is displayed. Overall, the appearance of the second web page 32 is very similar to that of the first web page 31, except a purchase request confirmation block or pop-up window 324 is created and displayed. The buyer may click the “yes” button 326 to confirm, or this transaction may be canceled by clicking the “no” button 328. The second web page 32 is used to ensure a confirmed purchase request from the buyer. The confirmed purchase request implies that the buyer has been authenticated and authorized for this particular online shopping transaction. In other words, the authenticated buyer authorizes the seller to charge at most the highest of the pre-set prices listed in the price-outcome correlation table 311. For the example shown in FIG. 3B, $10.20 is the highest possible price that the buyer would have to pay for this particular product.

Once the confirmed purchase request is received at the seller's online shopping transaction application, a third web page 33, shown in FIG. 3C, is rendered in which operation of rolling a die is simulated. For example, the gaming mechanism (i.e., moving four-faceted die 322) is put into a spinning motion 321 by the online shopping transaction application. The simulation of the operation of rolling the four-faceted die is continued for a pre-defined period of time. Alternatively the simulation would only be halted in response to a command from the buyer, for example, the buyer presses one of the keys on a keyboard or clicks the mouse button while curser is over the spinning die. The simulation of the die spinning motions and other visual and audio effects (e.g., flashing highlights of the correlation table 311) provides gaming experience that the buyer would not be able to enjoy if the buyer conducts online shopping transaction with any of the prior art approaches.

At the end of the pre-defined simulation period (e.g., a few seconds), one of the outcomes 332 of the gaming mechanism is presented in a fourth web page 34 illustrated in FIG. 3D. The actual sales price is the price corresponding to the determined outcome, which is distinguished from other undetermined outcomes and pre-set prices. In this example, the face of the die having four dots is the outcome, which corresponds to $9.90 from the correlation table 311. In order to produce each of the possible outcomes randomly, a mathematical algorithm called a random number generator or pseudo-random number generator is employed in the online shopping transaction application 114. Finally, an online shopping transaction summary 338 is displayed on the fourth web page 34, which notifies the buyer of the actual sales price and/or an account status (e.g., balance, charge, etc.). The actual outcome may also be highlighted with a flashing display, bright color or other audio or visual means to make the buyer excited as if a game was being played in the online shopping transaction.

While the gaming mechanism shown and described above comprises a four-faceted die 312, a six-sided cube corresponding to six different possible sales prices may alternatively be used. When activated, the cube is presented to the user/buyer as a spinning cube. After a predetermined period of time, the spinning is halted (e.g., after the user clicks on the spinning cube) and one of the six sides of the cube with an actual sales price is presented to the buyer.

Other alternative gaming mechanisms can alternatively be used, as will be appreciated by those of ordinary skill in the art. FIGS. 3E-3G show, for example, three other alternatives. In FIG. 3E, the gaming mechanism comprises a first wheel 342 similar to a roulette used in a gambling casino. The wheel 342 is divided into four sectors 344 with each sector corresponding to one of the pre-set prices. As the buyer submits the purchase request by clicking the “buy” button 310, the wheel 342 spins in a direction 343 for a pre-defined period of time. At the end of the spin, the actual sales price is the price associated with the sector pointed by the price determination indicator 341.

According to another embodiment, shown in FIG. 3F, the gaming mechanism comprises a second wheel 352 divided into a plurality of slots 354. Each slot is associated with one of the pre-set prices. When the buyer clicks the “buy” button 310, the wheel 352 spins for a pre-defined period of time in a direction indicated by a dashed line arrow 353. The actual sales price is the price indicated by the slot that appears adjacent to the price determination indicator 351 once the wheel 352 stops.

FIG. 3G shows yet another embodiment in which the gaming mechanism comprises a deck of playing cards 372. There are 13 possible distinct outcomes (i.e., 2, 3, 4, 5, 6, 7, 8, 9, 10, J, Q, K and A) for the playing cards. The first column 373 of a price-outcome correlation table 371 defines four subsets of the outcomes. Each subset corresponds to one of the prices listed in the second column 374. With the correlation table 371, any of the outcomes can be referred to one of the pre-set prices as the actual sales price.

While the exemplary embodiments above have been shown and described in the context of a few gaming mechanisms, the systems and methods of the present invention can also be adapted to operate using any other gaming mechanisms that are capable of producing a limited number of randomly generates or predetermined outcomes. A common feature in the embodiments described herein is that user-sensible characteristics of the gaming mechanism are displayed along with the plurality of the possible prices of the item for sale. Implementation of the gaming mechanism may be achieved using an applet included in computer code of the online shopping transaction application. The applet is downloaded from the seller's computing device and executed within the web browser installed on the buyer's computing device.

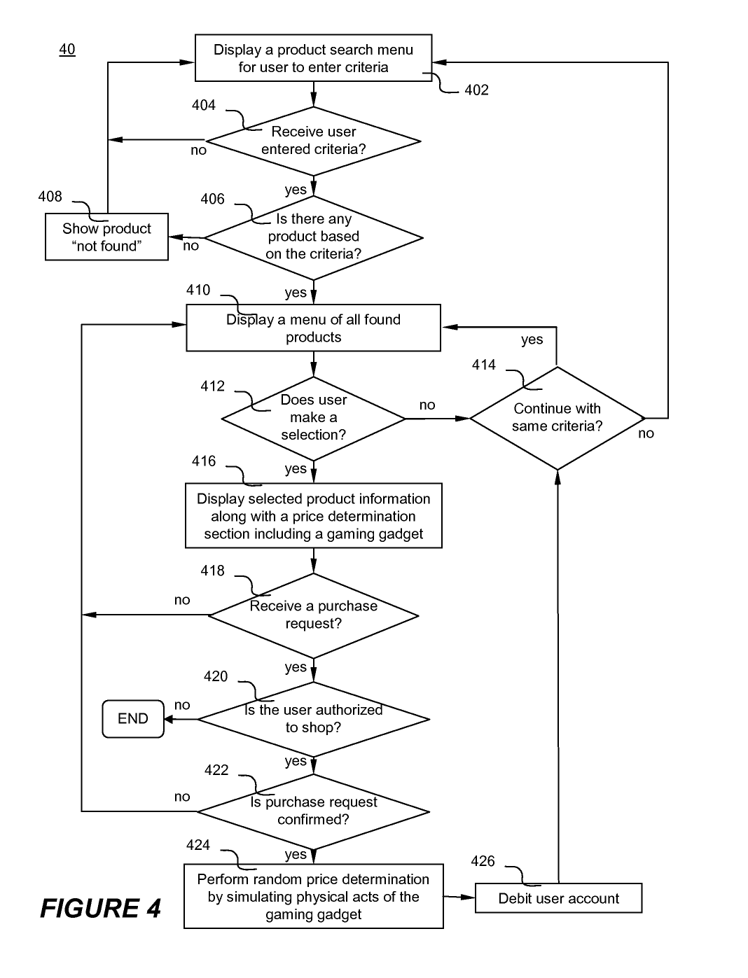

Referring now to FIG. 4, there is shown a flowchart illustrating an exemplary process 40 by which the system 10 in FIG. 1 operates to facilitate online shopping transactions with a gaming experience for buyers, according to an embodiment of the present invention.

Prior to receiving an instruction to search products (i.e., goods or services) from the user or buyer, the process 40 displays a search menu at 402 for the buyer to enter one or more search criteria. The process 40 shows the search menu, until the buyer enters certain categories that are desirous to acquire. Once the search criteria have been entered, decision 404 becomes “yes”. The process 40 moves to a decision 406, in which products that fit the entered search criteria are determined. If no match is found, a message indicating “products not found” is displayed at step 408 before the process 40 goes back to display the product search menu at step 402. If “yes”, at step 410 a menu of all products fit the entered search criteria (i.e., found products) is listed and displayed for the buyer or user to shop (i.e., browse and/or purchase).

Next, at decision 412 it is determined whether the buyer or user has made a selection from the menu. If “no”, the process 40 moves to another decision 414. If the buyer wishes to continue shopping with the same search criteria, the process 40 moves to step 410; otherwise, the process 40 moves back to step 402 to start over again for new search criteria. If “yes” at step 416, the online shopping transaction application 114 creates a webpage similar to the first web page 31 of FIG. 3A. The product title, detailed descriptions of the product, along with a price determination block or section is displayed in the webpage. In addition, a gaming mechanism configured to produce a set of random outcomes (or predetermined outcomes, in an alternative embodiment) is included in the price determination block.

The process 40 then moves to decision 418, in which it is determined if a purchase request has been received (e.g., if a “buy” button has been activated). If “no”, the process 40 goes back to step 410 to let the buyer make another selection from the menu that lists all found products. Otherwise, the process 40 moves to another decision 420 to determine if the buyer is authenticated and authorized to conduct this particular business transaction. For example, the buyer may be required to register and to place a credit card or bank account so that the seller can collect the sale proceeds. If the result of decision is “no”, the process 40 ends. It may require the buyer to register or valid a credit card, etc. If the decision 420 is “yes”, the second web page 32 of FIG. 3B is displayed. Another decision 422 is to ensure the buyer to make a confirmed purchase request. If “no”, the process again goes back to step 410. Otherwise, the buyer is committed to purchasing the selected product with one of the pre-set prices listed in the price-outcome correlation table. At step 424, the online shopping transaction application performs random price determination by simulating operation of the gaming mechanism (e.g., the third web page 33 of FIG. 3C). Next, at step 426, the user account is debited with the actual sales price determined in step 424 (e.g., the fourth web page 34 of FIG. 3D). Finally, the process 40 goes back to decision 414 to decide whether the buyer wishes to do more shopping in the same search criteria. If “yes”, the process 40 goes to step 410; otherwise step 402. The process 40 repeats for prospective buyers.

In general, the methods described above, including the processes performed by the online shopping transaction application 114, are performed by applets, servlets, or software routines executing in a computer system. The routines may be implemented by any number of computer programming languages such as, for example, Hypertext Markup Language, (HTML), Java, C, C++, Pascal, FORTRAN, assembly language, etc. Further, various programming approaches such as procedural, object-oriented or artificial intelligence techniques may be employed. As is understood by those of ordinary skill in the art, the program code corresponding to the methods and processes described herein may be stored on a computer-readable medium. Depending on each particular implementation, computer-readable media suitable for this purpose may include, without limitation, floppy diskettes, compact disks (CDs), hard drives, networked attached storage devices, random access memory (RAM), read only memory (ROM) and flash memory.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the gaming mechanism has been shown and described as comprising a vertically or horizontally mounted roulette-like wheel, a multi-faceted die, or a deck of playing cards, any other gaming mechanisms capable of producing a set of random, pseudo-random or predetermined outcomes, may also be used.

For at least these reasons, therefore, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of facilitating an online shopping transaction, comprising:
receiving a request to purchase an item offered for sale by an online seller from an online buyer, said request to purchase including an agreement to purchase said item at one of a plurality of possible sales prices; and
in response to receiving said request to purchase the item offered for sale, determining an actual sales price of the item from among said plurality of possible sales prices using a gaming mechanism.

2. The method of claim 1, further comprising displaying a relationship between said plurality of possible sales prices and a plurality of possible outcomes of said gaming mechanism to the buyer.

3. The method of claim 1, further comprising displaying visual attributes of the gaming mechanism to the buyer.

4. The method of claim 3 wherein displaying visual attributes of the gaming mechanism to the buyer comprises displaying time-varying visual effects of the gaming mechanism.

5. The method of claim 4, further comprising visually distinguishing a display of the actual sales price from a display of the remaining possible, but undetermined, sales prices of the plurality of possible sales prices to the buyer, after determining the actual sales price of said item.

6. The method of claim 3 wherein determining said actual sales price is performed by randomly or pseudo-randomly selecting from among said plurality of possible sales prices.

7. The method of claim 3 wherein the visual attributes of said gaming mechanism comprise a multi-faceted three-dimensional structure having one or more faces that correspond to said plurality of possible sales prices or to said actual sales price.

8. The method of claim 1 wherein the visual attributes of said gaming mechanism comprise a circular disc or wheel partitioned into a plurality of slots, one or more slots of said plurality of slots corresponding to said plurality of possible sales prices or to said actual sales price.

9. The method of claim 1 wherein the visual attributes of said gaming mechanism comprise one or more playing cards.

10. The method of claim 1 wherein the visual attributes of said gaming mechanism comprise one or more dice.

11. A system for facilitating an online shopping transaction that includes a gaming experience for buyers, comprising:
a first computing subsystem adapted to offer an item for sale according to operation of a gaming mechanism; and
a second computing subsystem configured to access said offer via a computer network and display visual attributes of said gaming mechanism to an operator of the second computing system,
wherein said first computing subsystem is operable to receive an agreement from said operator to purchase said item at a price determined by said gaming mechanism.

12. The system of claim 11, further comprising means for displaying a plurality of possible sales prices said operator agrees to pay for said item and relationships among said plurality of possible sales prices and one or more of said visual attributes of said gaming mechanism.

13. The system of claim 11, further comprising means for generating visually displayable and time-varying attributes of said gaming mechanism.

14. The system of claim 11 wherein the first computing subsystem is configured to offer the item for sale to said operator of said second computing subsystem for a plurality of possible sales prices, and said gaming mechanism is operable to determine an actual sales prices from among the plurality of possible sales prices in response to receiving said agreement from said operator to purchase said item at a price determined by said gaming mechanism.

15. The system of claim 14 wherein the gaming mechanism is further configured to determine the actual sales price from among the plurality of possible sales prices by randomly or pseudo-randomly selecting from among the plurality of possible sales prices.

16. The system of claim 14 wherein the actual sales price determined by the gaming mechanism from among the plurality of possible sales prices is predetermined.

17. A method of facilitating an online shopping transaction between an online shopper and an online seller, comprising:
providing computer code of one or more web pages to a browser of a computer operated by an online shopper, said computer code including a gaming mechanism and instructions for said browser to display a plurality of possible sales prices of an item for sale and visual attributes of said gaming mechanism corresponding to the plurality of possible sales prices; and
determining an actual sales price the shopper agrees to pay for said item from said plurality of possible sales prices, by operation of said gaming mechanism.

18. The method of claim 17 wherein determining the actual sales price the shopper agrees to pay for said item is triggered by a request to purchase said item from said shopper.

19. The method of claim 17 wherein said computer code includes instructions that provide said shopper the ability to interact with said gaming mechanism via said browser.

20. The method of claim 19 wherein the instructions that provide said shopper the ability to interact with said gaming mechanism include instructions that allow said shopper to activate or halt operation of said gaming mechanism.

21. The method of claim 19 wherein the instructions for said browser to display the plurality of possible sales prices of the item for sale and/or to display visual attributes of said gaming mechanism comprises an applet.

22. A method of conducting an online shopping transaction, comprising:
offering an item for sale to an online shopper;
presenting attributes of a gaming mechanism to said online shopper, said gaming mechanism attributes including a plurality of user-sensible characteristics corresponding to a plurality of possible sales prices of said item; and
selecting an actual sales price from among said several possible sales prices, based on operation of said gaming mechanism.

23. The method of claim 22 wherein selecting the actual sales price from among said several possible sales prices comprises selecting the actual sales price in response to the online shopper's interaction with said gaming mechanism.

24. A computer-usable medium having a computer readable medium stored thereon for execution by a processor to perform a method comprising:
presenting a web page showing an item for sale and attributes of a gaming mechanism to an online shopper, said gaming mechanism attributes including a plurality of user-sensible characteristics corresponding to a plurality of possible sales prices of said item; and
selecting an actual sales price from among said several possible sales prices, based on operation of said gaming mechanism.

25. The computer-usable medium of claim 24 wherein selecting the actual sales price from among said several possible sales prices comprises selecting the actual sales price in response to the online shopper's interaction with said gaming mechanism.
